(19) United States
(12) Patent Application Publication
(10) Pub. No.: US 2008/0291687 A1
(43) Pub. Date: Nov. 27, 2008

(54) Optical filter assembly and method

(75) Inventors: Kenneth Braganca, Ronkonkoma, NY (US); Peter J. Murphy, Huntington, NY (US)

Correspondence Address: The Plevy Law Firm, 10 Rutgers Place, Trenton, NJ, 08618, US

(73) Assignee: Designs for Vision, Inc., Ronkonkoma, NY (US)

(21) Appl. No.: 12/012,427

(22) Filed: Feb. 1, 2008

Related U.S. Application Data
(60) Provisional application No. 60/931,406, filed on May 22, 2007.

(51) Int. Cl. F21V 11/00

(52) U.S. Cl. 362/510

(57) ABSTRACT

A filter assembly includes a mounting element for receiving and mounting on a forward portion of a headlight, and a central opening, and a frame rotatably coupled to the mounting element, the frame having an optical filter for selectively blocking wavelengths below a first limit from the optical path between the source and the output. The frame is rotatable between a closed position in which the filter substantially covers the central opening of the mounting element, and an open position in which the central opening of the mounting element is substantially open. Both the mounting element and the frame have a central axis through their respective openings, which axis is substantially the central axis of light being emitted from a headlight when the filter assembly is mounted on a headlight.

### RELATED APPLICATIONS

This patent application claims the benefit under 35 U.S.C. 119 (e) of U.S. Provisional Application No. 60/931,406, filed May 22, 2007, the entire disclosure of which is hereby incorporated by reference herein.

### FIELD OF THE INVENTION

This invention is in the field of illumination, and particularly relates to optical filters for illuminating headlights.

### BACKGROUND

Illuminating headlights are used in a wide variety of contexts to provide illumination at a particular location, while leaving the hands free. Such headlights have application, for example, in the fields of dentistry and medicine. Prior art headlights typically have a remote source of illumination, connected by a fiber optic cable to a headset. The remote source of illumination is typically a bulb, which may be for example, a metal halide or a xenon bulb. The bulb output is typically focused using a reflector on a fiber optic cable, and a lens is provided at the output of the fiber optic cable, in the headlight.

Filtering of light output by a headlight is often desirable. By way of example, a filter to reduce transmission in the ultraviolet and near-ultraviolet wavelengths may be desirable when working with adhesives that are UV-curable. Filters are available in a variety of forms, including lenses and sheets, which can be placed in a holder that can be removably fitted on a headlight.

### SUMMARY OF THE INVENTION

In one embodiment of the invention, an optical filter assembly includes a mounting element having a bore defined therein for receiving and mounting on a forward portion of a headlight, and a central opening, and a frame rotatably coupled to the mounting element, the frame having an optical filter therein. The frame is rotatable between a closed position in which the filter substantially covers the central opening of the mounting element, and an open position in which the central opening of the mounting element is substantially open. Both the mounting element and the frame have a central axis through their respective openings, which axis is substantially the central axis of light being emitted from a headlight when the filter assembly is mounted on a headlight. In an embodiment, the frame is rotatable about an axis of rotation substantially parallel to the central axis. In an embodiment, the filter assembly includes a connection assembly. The connection assembly may include a smooth shaft fixed in one of the frame and the mounting element, and free to rotate with respect to the other of the frame and the mounting element. In some embodiments, the connection assembly may include a shaft having first and second indentations, separated by an angular distance of about 135 degrees, and a ball plunger positioned with a ball to engage the first and second indentations.

In another embodiment of the invention, a device selectively controls the wavelength of light transmitted from a source that emits light along an optical path toward an output, comprising: a rotatable filter adapted to be selectively disposed in the optical path for selectively blocking wavelengths below a first limit from the optical path between the source and the output; said filter controlling the intensity and the wavelength of light to prevent said light from curing an adhesive curable at the said blocked wavelengths of light.

In yet another embodiment of the invention a process selectively controls the wavelength of light transmitted from a source that emits light along an optical path toward an output, comprising: rotating a filter into the optical path for selectively blocking wavelengths below a first limit from the optical path between the source and the output wherein said filter determines the intensity and the wavelength of light to prevent said light from curing an adhesive curable at the said blocked wavelengths of light.

In yet another embodiment of the invention a method for applying a light source to cure an adhesive comprising the steps of: rotating a filter into a first position to block wavelengths below 530 nm from light source from illuminating an object; applying an adhesive to the object curable in wavelengths of illumination above 405 nm; rotating the filter into a second position to allow wavelengths above 405 nm from light source to illuminate the adhesive.

### BRIEF DESCRIPTION OF THE FIGURES

The advantages, nature, and various additional features of the invention will appear more fully upon consideration of the illustrative embodiments now to be described in detail in connection with accompanying drawings where like reference numerals identify like elements throughout the drawings:

FIG. 1 is an isometric drawing of an exemplary filter assembly according to an embodiment of the invention.

FIG. 2 are plan views (side and front) of the exemplary filter assembly of FIG. 1.

FIG. 3 is an isometric drawing showing the exemplary filter assembly of FIG. 1.

FIG. 4 is an isometric drawing of a shaft of the exemplary connection assembly of FIG. 3.

FIG. 5 is an isometric drawing of an alternative embodiment of a shaft of the exemplary connection assembly of FIG. 3.

FIG. 6 is an isometric drawing showing the exemplary filter assembly of FIG. 1 in an open position.

### DETAILED DESCRIPTION

It is to be understood that the figures and descriptions of the present invention have been simplified to illustrate elements that are relevant for a clear understanding of the present invention, while eliminating, for purposes of clarity, many other elements found in illuminating headsets. However, because such elements are well known in the art, and because they do not facilitate a better understanding of the present invention, a discussion of such elements is not provided herein. The disclosure herein is directed to all such variations and modifications known to those skilled in the art.

It will also be appreciated that the illustrations of an embodiment of the invention depicted in the figures include ornamental features and aspects, which ornamental features and aspects may be altered without altering any functional features or aspects of the embodiment.

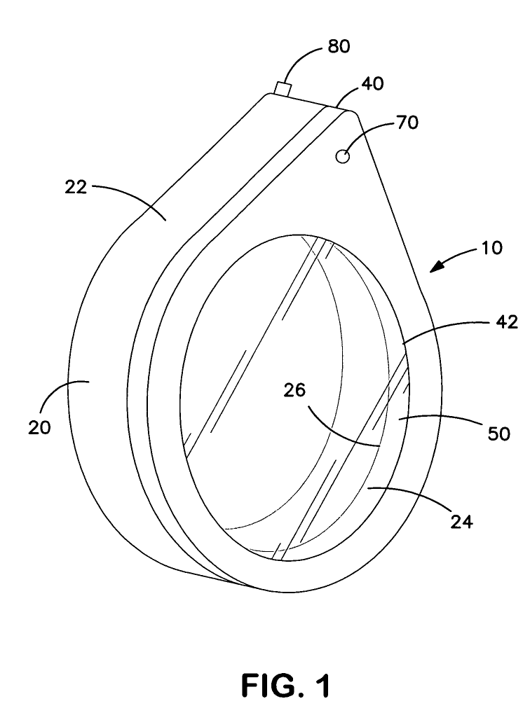

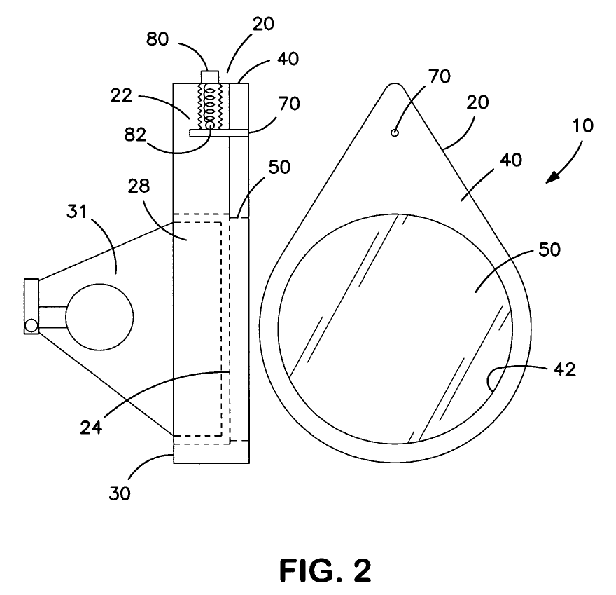

Referring now to FIGS. 1 and 2, a device in accordance with an embodiment of the invention is illustrated. A filter assembly 10 includes a mounting element 20 coupled to a frame 40. Mounting element 20 may be coupled to frame 40 so that frame 40 may rotate with respect to mounting element 20. When frame 40 is in the orientation shown in FIG. 1, a central opening in mounting element 20 is aligned with a central opening in frame 40. Filter 50 is positioned in frame 40 so as to cover the central opening of frame 40 completely.

As shown in FIG. 2 the mounting element 20 is adapted to engage on a headlight 31 mounted within a cone shaped housing 32. The headlight may be any illumination device such as an LED, incandescent or fluorescent lamp. An electrical connection 34 attached to a lamp base 33. Mounting element 20 may have a generally cylindrical form, having a continuous wall 22 having an interior surface 24 having a form complementary to an exterior surface of a wall at a forward edge of a headlight 31. In the illustrated embodiment, as seen in FIG. 2, interior surface 24 is in the form of a right circular cylinder. Accordingly, mounting element 20 is adapted for fitting on headlight 31 having a right circular cylindrical outer wall at its forward edge. The headlight 31 may have a different shape, such as oval, square, rectangular, or other polygonal shape, and interior surface 24 may be shaped to have a complementary shape.

The interior surface 24 is smooth at a proximal edge 26 (see, FIG. 1). In one embodiment (not shown), the headlight 31 may be integrated into a lens 28 or may comprise a separate headlight 31 and a separate lens 28 as depicted. A central opening is defined within mounting element 20 to permit the passage of light there through from a headlight 31.

Referring to FIGS. 1 and 2, frame 40 has a shape that matches the shape of mounting element 20, and in this example is generally cylindrical. Frame 40 generally has an extending lip 42, shown in FIGS. 1 and 2. Filter 50 is rigidly fixed on frame 40, such as by a suitable adhesive. In the illustrated embodiment, filter 50 is in the form of a sheet.

Mounting element 20 and frame 40 may be of a rigid material. In some embodiments, mounting element 20 and frame 40 may be made of a plastic, such as an acetal resin, such as that sold under the brand name DELRIN B, which materials are also known as polyoxymethylene (POM), polytrioxane and polyformaldehyde. A material having a relatively low coefficient of friction may be employed. By way of example, a material having a coefficient of friction of about 0.25 when dry vs. steel may be employed. A relatively low coefficient of thermal expansion, such as about 47 pinlin-″F is also desirable. A relatively lightweight material is also desirable.

Mounting element 20 and frame 40 are joined by a connection assembly, described below. The ends of shaft 70, which is part of the connection assembly, and the top of ball plunger set screw 80, also part of the connection assembly, may be seen in FIGS. 1 and 2.

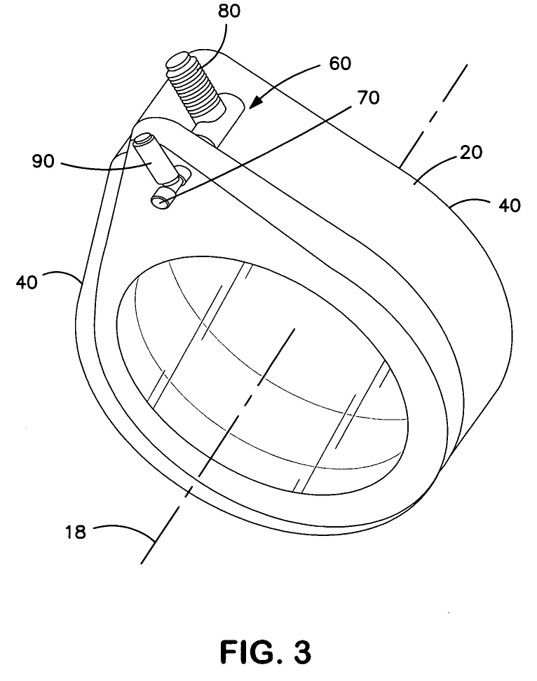

Referring to FIG. 3, mounting element 20 and frame 40 are shown as transparent, so that the relative position of a connection assembly 60 may be seen. Connecting assembly 60 includes shaft 70. Shaft 70 is rigidly coupled to one of mounting element 20 and frame 40, and rotates freely with respect to the other one of mounting element 20 and frame 40. In the illustrated embodiment, shaft 70 is rigidly coupled to frame 40, and rotatable within mounting element 20.

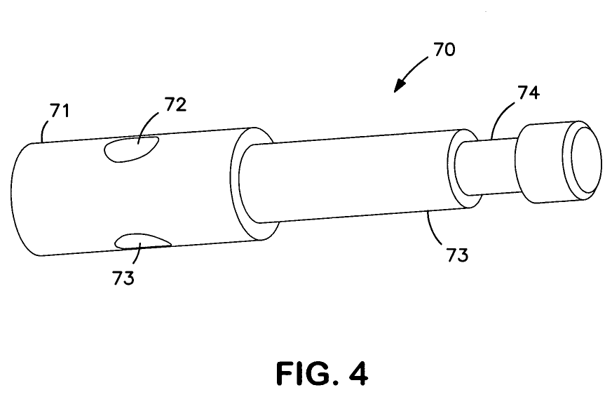

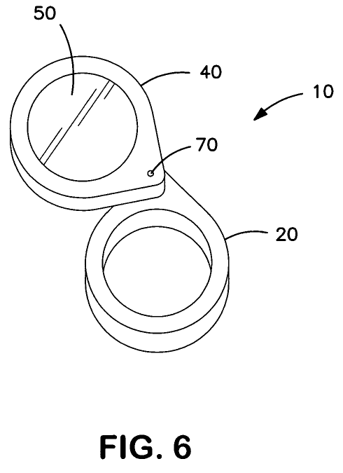

As may be seen with reference to FIGS. 3 and 4, shaft 70, which may also be described as a dowel pin, is oriented with its longitudinal axis substantially parallel to the central axis 18 of mounting element 20 and frame 40. In the embodiment shown in FIG. 4, at portion 71, which is rotatably positioned in a corresponding bore in an upper portion of mounting element 20, two indentations 72, 73, which may have the form of a section of a sphere, are provided. Indentations 72, 73 are disposed approximately 135 degrees, center-to-center, from one another, about the circumference of shaft 70. Ball plunger set screw 80, shown in FIG. 2 includes a spring-loaded ball 82, is positioned perpendicular to shaft 70 in a corresponding bore in mounting element 20. Spring loaded bail 82 engages indentations 72 when the user rotates frame 40, and thereby rotates shaft 70, so that spring loaded bail is aligned with one of indentations 72. Indentations 72 are so located that frame 40 thus has a stop position when its central opening is aligned with the central opening of mounting element 20. This position is shown, for example, in FIGS. 1 and 3. In this position, filter 50 covers the central opening of mounting element 20 so that substantially all light emitted by a headlight on which filter assembly 10 is mounted is transmitted through filter 50. When the user rotates frame 40 approximately 135 degrees in the proper direction from the aligned position, then ball 82 is received in indentation 73, and frame 40 is positioned so that light emitted from a headlight is not received by filter 50 (see, FIG. 6).

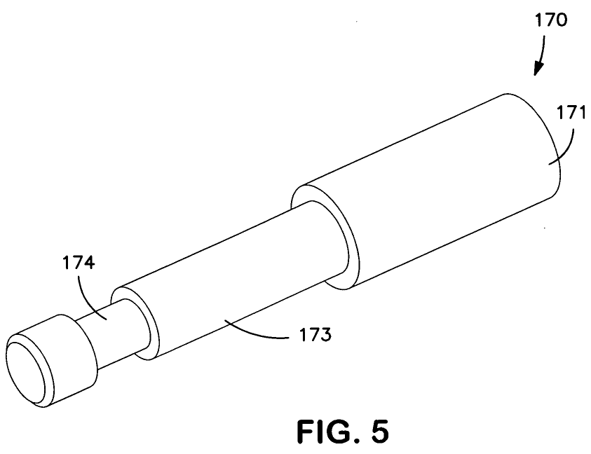

As shown in FIG. 3, set screw 80 is positioned in a bore in frame 40 substantially normal to shaft 70. Set screw 80 is positioned so as to be received in a groove 74 in narrow portion 73 of shaft 70, shown in FIG. 4. Set screw 80 is threaded, and the lower end of set screw 80 is flat. Set screw 80 serves to prevent shaft 70 from moving longitudinally with respect to frame 40. Set screw 80 may have a slot in its upper end to facilitate engagement by a tool. Similarly, in an embodiment having shaft 170 of FIG. 5, set screw 50 is positioned so as to be received in groove 174 in narrow portion 173 of shaft 170. Thus, set screw 80 serves to prevent shaft 170 from moving longitudinally with respect to frame 40.

In an alternative embodiment of the shaft as shown in FIG. 5, portion 171 does not include indentations, and has a continuous cylindrical outer surface. The ball 82 of ball plunger set screw 80 rides on portion 171.

The components of connection assembly 60 may be of a material having high wear resistance, such as steel.

The filter may be, by way of example, NoIR No. 60L, which provides approximately no spectral transmission at wavelengths below about 530 nm. It will be appreciated that alternative embodiments may include optical filters having other characteristics, such differing thresholds, or filtering particular bands within the optical spectrum.

In one non limiting embodiment of the invention, the bore of mounting element 20 may have an inside diameter of about 1.15 inches; the central opening in lip 28 may have an inside diameter of about 1.0 inch, and the thickness of the mounting element may be about 0.342 inches, with the inner lip having a thickness of about 0.03 inches. The outside surface may have a radius of about 0.625 inches. The frame may have a thickness of about 0.155 inches, and an inner diameter of its inner opening of about 1.0 inch.

In a method of use, an assembly 10 is placed on a headlight so that mounting element 20 engages the headlight. Frame 40 is positioned so that the respective central openings are aligned. The user may do this, in an embodiment having the shaft 70 of FIG. 4, by rotating frame 40 by hand until the change in resistance to rotation when the ball 82 is in the appropriate one of indentations 72, 73 is detected. In an embodiment having the shaft 170 of FIG. 5, the user may do this by moving the frame by hand until the respective outer edges of the frame and the mounting element are aligned. The user may then illuminate a headlight, and illuminate a target using optical filtering. When it is desired to illuminate without optical filtering, the user moves frame 40 by hand until, in an embodiment having the shaft 70 of FIG. 4, detecting the change in resistance to rotation when the ball 82 is in the other one of indentations 72, 73, at an angular distance of about 135 degrees from the previous location. In an embodiment having the shaft 170 of FIG. 5, the user moves frame 40 by hand until frame 40 and filter 50 are entirely or substantially not blocking the central opening.

With reference to FIGS., 1,2 3 and 6, another embodiment of the invention comprises the device 10 that selectively controls the wavelength of light transmitted from a source that emits light, such as headlight 31 along an optical path toward an output. The rotatable filter 50 utilizing shaft 70 and set screw 80 such in assembly 10 mounted for transmission is adapted to be selectively disposed in the optical path for selectively blocking wavelengths below a first limit from the optical path between the source and the output; said filter 50 controlling the intensity and the wavelength of light to prevent said light from curing an adhesive curable at the said blocked wavelengths of light.

In yet another embodiment of the invention a process selectively controls the wavelength of light transmitted from a source that emits light such as headlight 31 along an optical path toward an output, comprising: rotating filter 50 utilizing shaft 70 and set screw 80 into the optical path for selectively blocking wavelengths below a first limit from the optical path between the source and the output wherein said filter 50 determines the intensity and the wavelength of light to prevent said light from curing an adhesive curable at the said blocked wavelengths of light.

In yet another embodiment of the invention a method for applying a light source to cure an adhesive comprising the steps of: rotating filter 50 utilizing shaft 70 and set screw 80 into a first position to block wavelengths below 530 nm from light source such as headlight 31 from illuminating an object; applying an adhesive to the object curable in wavelengths of illumination above 405 nm; rotating the filter into a second position to allow wavelengths above 405 nm from light source to illuminate the adhesive.

Advantages of the invention include that the assembly may be permanently mounted on a headlight, instead of requiring the user to place a filter in a housing on a headlight each time a filter is desired. The assembly may be permanently secured by an adhesive, for example. The ball plunger and corresponding indentations on the shaft permit the user to tell by feeling the change in resistance whether the filter is in the filtering position or moved out of the way readily. The user may also, using one hand, properly move the filter into position to provide filtering of light emitted by the light, or temporarily move the filter so as to provide an unfiltered output.

While the foregoing invention has been described with reference to the above described embodiment, various modifications and changes can be made without departing from the spirit of the invention. Accordingly, all such modifications and changes are considered to be within the scope of the invention.

We claim:

1. A device for selectively controlling the wavelength of light transmitted from a source that emits light along an optical path toward an output, comprising: a rotatable filter adapted to be selectively disposed in the optical path for selectively blocking wavelengths below a first limit from the optical path between the source and the output; said filter controlling the intensity and the wavelength of light to prevent said light from curing an adhesive curable at the said blocked wavelengths of light.

2. The device of claim 1, wherein said filter has a first position in said optical path and a second position outside said optical path.

3. The device of claim 1, wherein wavelengths below a first limit comprise wavelengths less than 530 nm.

4. The device of claim 2, wherein when said filter is in the second position outside said optical path the adhesive cures.

5. The device of claim 4, wherein light in excess of 405 nm cures the adhesive.

6. A process for selectively controlling the wavelength of light transmitted from a source that emits light along an optical path toward an output, comprising: rotating a filter into the optical path for selectively blocking wavelengths below a first limit from the optical path between the source and the output wherein said filter determines the intensity and the wavelength of light to prevent said light from curing an adhesive curable at the said blocked wavelengths of light.

7. A method for applying a light source to cure an adhesive comprising the steps of: rotating a filter into a first position to block wavelengths below 530 nm from light source from illuminating an object; applying an adhesive to the object curable in wavelengths of illumination above 405 nm; rotating the filter into a second position to allow wavelengths above 405 nm from light source to illuminate the adhesive.

8. A device for selectively controlling the wavelength of light transmitted from a source that emits light along an optical path toward an output, comprising: a mounting element having a bore defined therein for receiving and mounting on a forward portion of a headlight, and a central opening, and a frame rotatably coupled to the mounting element, the frame having an optical filter therein.

9. The device of claim 8, wherein said frame is rotatable between a closed position in which the filter substantially covers the central opening of the mounting element, and an open position in which the central opening of the mounting element is substantially open.

10. The device of claim 8, wherein said mounting element and the frame have a central axis through their respective openings, which axis is substantially the central axis of light being emitted from a headlight when the filter assembly is mounted on a headlight.

11. The device of claim 8, wherein said frame is rotatable about an axis of rotation substantially parallel to the central axis.

12. The device of claim 8, wherein said filter assembly includes a connection assembly.

13. The device of claim 12, wherein said connection assembly includes a smooth shaft fixed in one of the frame and the mounting element, and each is free to rotate with respect to the other of the frame and the mounting element.

14. The device of claim 12, wherein said the connection assembly includes a shaft having first and second indentations, separated by an angular distance of about 135 degrees, and a ball plunger positioned with a ball to engage the first and second indentations.
